(19) United States
(12) Patent Application Publication
(10) Pub. No.: US 2012/0023704 A1
(43) Pub. Date: Feb. 2, 2012

(54) Friction Hinge

(76) Inventor: Ryan R. Case, Pinckney, MI (US)

(21) Appl. No.: 12/517,961

(22) PCT Filed: Dec. 6, 2007
(86) PCT No.: PCT/CA07/02190

§ 371 Date: Jul. 26, 2011

Related U.S. Application Data
(60) Provisional application No. 60/868,745, filed on Dec. 6, 2006.

(30) Foreign Application Priority Data
Dec. 6, 2006 (US) 60868745

(51) Int. Cl. E05D 11/08; E05D 11/10

(52) U.S. Cl. 16/321; 16/337

(57) ABSTRACT

A sub-component of a friction hinge (10, 100, 200, 300, 400, 500, 600) includes a member (14, 204) including a connection portion (28, 128, 228) defining a passage (36), wherein the passage (36) includes a splined circumferential inner periphery (38), and wherein the member (14, 204) defines a gap (30, 230a); and a shaft (16) including a splined (34) circumferential outer profile (32) movably-engaged with the circumferential inner periphery (38) of the member (14, 204a) to connect the connection portion (28, 128, 228) about an axis of rotation (A-A) extending through the shaft (16), wherein the gap (30, 230a) axially extends in a substantial parallel relationship to the axis of rotation (A-A). A friction hinge (10, 100, 200, 300, 400, 500, 600) is also disclosed.

### BACKGROUND

1. Technical Field

The invention relates to a friction hinge including cooperating inner and outer shafts.

2. Description of Related Art

Friction hinges are known in the art and are typically utilized for maintaining an object connected to the friction hinge at a predetermined position, angle, or the like. According to a known application, friction hinges are commonly associated with portable laptop computers including a monitor that is pivotably-coupled to a base portion including a keyboard. As such, friction hinges may, according to the above-described application, be utilized in a manner to maintain a monitor at a desired angle relative the base portion.

Although conventional friction hinges are known in the art and have been utilized in numerous applications, global competitive forces demand that material and manufacturing costs are reduced to provide a manufacturer with a profit. As such, there is a need in the art to reduce manufacturing time and number of parts typically associated with friction hinges, such as, for example, steel torsion springs, clips, and the like.

### BRIEF DESCRIPTION OF THE DRAWINGS

The present disclosure will now be described, by way of example, with reference to the accompanying drawings, in which:

FIG. 1 is a perspective view of a friction hinge in accordance with an exemplary embodiment of the invention;

FIG. 2 is a partial perspective, cross-sectional view of a friction hinge according to FIG. 1;

FIG. 3A is a cross-sectional view of the friction hinge according to FIG. 2;

FIG. 3B is another cross-sectional view of the friction hinge according to FIG. 3A;

FIG. 3C is another cross-sectional view of the friction hinge according to FIG. 3B;

FIG. 4 is a perspective view of a friction hinge in accordance with an exemplary embodiment of the invention;

FIG. 5 is a perspective view of a friction hinge in accordance with an exemplary embodiment of the invention;

FIG. 6 is a partial, top perspective, cross-sectional view of a friction hinge according to FIG. 5;

FIG. 7 is a partial, bottom perspective, cross-sectional view of a friction hinge according to FIG. 5;

FIG. 8 is a cross-sectional view of a friction hinge according to an exemplary embodiment;

FIG. 9A is a magnified view of FIG. 3A in accordance with an exemplary embodiment of the invention;

FIG. 9B is a magnified view of FIG. 8 in accordance with an exemplary embodiment of the invention;

FIG. 10A is a cross-sectional view of the friction hinge in accordance with an exemplary embodiment of the invention;

FIG. 10B is a cross-sectional view of the friction hinge in accordance with an exemplary embodiment of the invention; and

FIG. 10C is a cross-sectional view of the friction hinge in accordance with an exemplary embodiment of the invention.

### DETAILED DESCRIPTION

The Figures illustrate an exemplary embodiment of a friction hinge 10, 100, 200 in accordance with an embodiment of the invention. For brevity, the disclosure hereof will illustrate and describe a friction hinge 10, 100, 200 that maintains an object connected to the friction hinge 10, 100, 200 at a predetermined position, angle, or the like. Based on the foregoing, it is to be generally understood that the nomenclature used herein is simply for convenience and the terms used to describe the invention should be given the broadest meaning by one of ordinary skill in the art.

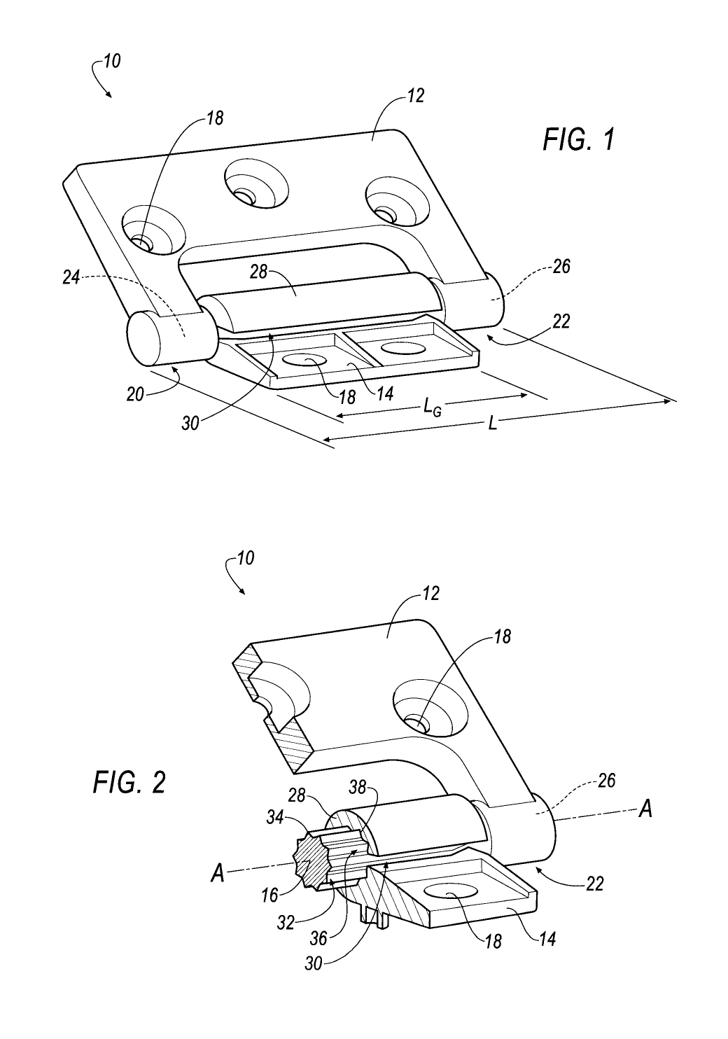

Referring to FIGS. 1 and 2, a friction hinge is shown generally at 10 according to an embodiment. The friction hinge 10 includes a first member 12, a second member 14, and a shaft 16 (FIG. 2) that pivotably-connects the first member 12 relative the second member 14. As illustrated in FIG. 1, the first and second members 12, 14 include a plurality of openings 18 that respectively accommodate passage of a fastener (not shown). As such, when fasteners are passed through the plurality of openings 18, the fasteners may secure the first and second members 12, 14 to a first body (not shown) and a second body (not shown), respectively.

According to an embodiment, the first body may include, for example, a monitor of a laptop computer, and the second body may include, for example, a base of a laptop computer including a keyboard. However, it will be appreciated that the first and second bodies may not be limited to portions of a laptop computer and may be directed to any desirable application. As such, according to an embodiment, the first body may include, for example, a door of a storage compartment in an automotive vehicle, and the second body may include, for example, a receptacle portion of a storage compartment in an automotive vehicle. Thus, it will be appreciated upon considering this present disclosure that the friction hinge 10 is not limited to a particular application and may be utilized in conjunction with any desirable application, as desired.

As illustrated in FIG. 1, the first member 12, according to an embodiment, is formed to include a C-shape, having first and second ends 20, 22 that are rigidly fixed to first and second ends 24, 26 of the shaft 16. The second member 14, according to an embodiment, is formed to include a J-shape having a shaft portion 28 that circumferentially wraps-around the shaft 16. Although the shaft portion 28 is said to wrap around the shaft 16, it will be appreciated that the shaft portion 28 is shaped to partially wrap, in a circumferential manner, around the shaft 16. For reasons discussed below, the partial, incomplete circumferential wrapping of the shaft portion 28 about the shaft 16, according to an embodiment, is provided by including an absence of material or a gap 30 extending across a length, L_{G}, of the shaft portion 28. Because the shaft portion 28 circumferentially wraps-around the shaft 16, the shaft 16 may also be referred to as an inner shaft whereas the shaft portion 28 may be referred to as an outer shaft.

According to an embodiment, the friction hinge 10 may be formed from two or more materials in a mold tool (not shown) by way of a multi-shot molding/over-molding process. According to an embodiment, as explained below in further detail, the shaft 16 is formed from a rigid material whereas the second member 14 is formed from an elastic material.

According to an embodiment, the friction hinge 10 may be formed in a mold tool that may provide a plurality of different volumes to form the first member 12, second member 14, and shaft 16. According to an embodiment, the mold tool may provide a first cavity volume that receives a first shot of a rigid material that defines the shaft 16. Then, the mold tool may provide a second cavity volume that receives a second shot of a rigid material that over-molds portions of the shaft 16 to define the first member 12. Then, the mold tool may provide a third cavity volume that receives a third shot of material, such as, for example, an elastic material, that over-molds a portion of the shaft 16 to define the second member 14.

As such, according to an embodiment, the friction hinge 10 may be formed as a “three-shot” product in a multi-shot mold tool. However, it will be appreciated that the friction hinge 10 may be formed as a “two-shot” product, if, for example, a single shot of rigid material is utilized to form an integrated shaft 16 and first member 12 and a second shot of elastic material is utilized to form the second member 14. In addition, there are a variety of techniques that permit an altering of the volume of a mold tool cavity; such techniques may include, for example, the use of moveable cores, slides, transfer molds, or a rotating member.

Referring now to FIG. 2, a cut-away, perspective view of the friction hinge 10 is shown according to an embodiment. As illustrated, the shaft 16 includes a circumferential profile, which is shown generally at 32. According to an embodiment, the circumferential profile 32 includes a splined surface including toothed or grooved portions 34 that extend, axially, from the first end 24 to the second end 26 of the shaft 16 along a length, L (FIG. 1), of the friction hinge 10. As also shown in FIG. 2, the shaft portion 28 is generally defined to include a passage 36 including a profile that receives the circumferential profile 32 of the shaft 16. According to an embodiment, the profile of the passage 36 is also shaped to include a splined surface including toothed or grooved portions 38 that corresponds to the toothed or grooved portions 34 of the shaft 16.

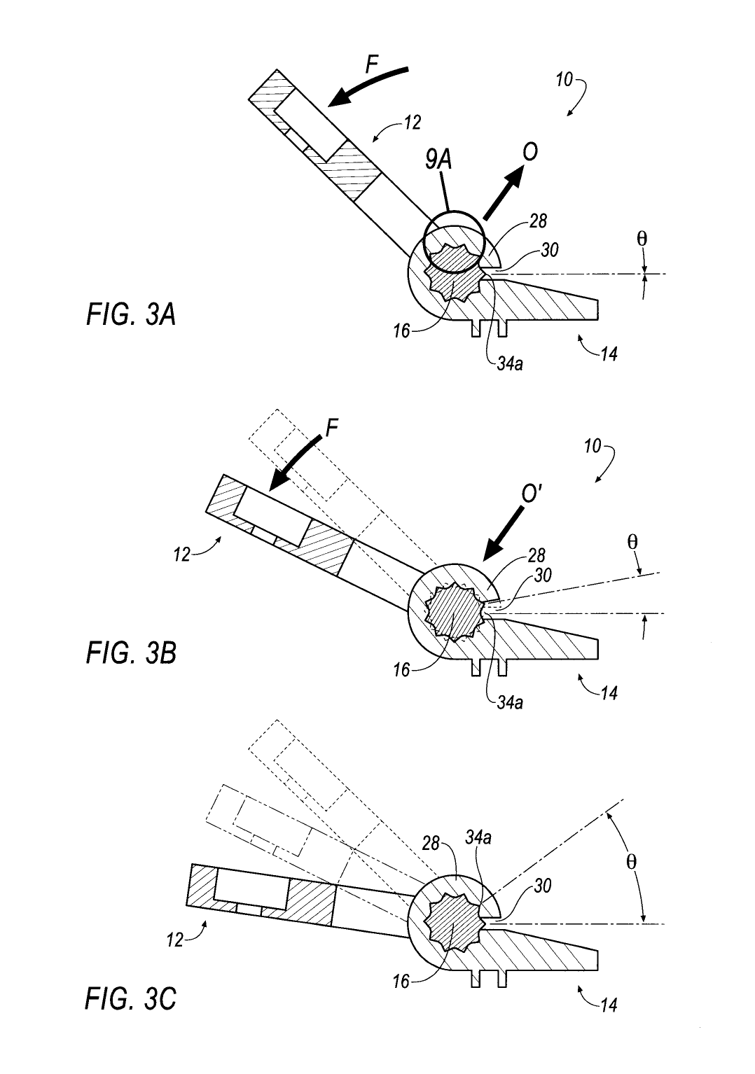

According to an embodiment, the toothed or grooved portions 34, 38 of the inner and outer shafts 16, 28 provides a means to frictionally-engage the first and second members 12, 14 with one another such that the first and second members 12, 14 are not able to freely move about the shaft 16 unless a force, such as, for example, a force, F, shown in FIGS. 3A, 3B, is applied to one of the first and second members 12, 14. Although the following description in FIGS. 3A-3C includes a force, F, applied to the first member 14 while the position of the second member 16 is held constant, it will be appreciated that the reverse condition may be applicable where a force, F, is applied to the second member 14 while the first member 12 is held constant, or, in another embodiment, if desired, divergent forces may be applied to each of the first and second members 12, 14 to permit movement of the first and second members 12, 14 about the shaft 16.

As seen in FIGS. 3A and 3B, movement of the first member 12 relative the second member 14 is permitted (with the first member 12 shown in phantom in FIG. 3B) when the force, F, is applied to the first member 12 as the relative positioning of the second member 14 is held constant. As such, when the force, F, is applied to the first member 12, the force, F, may be translated to the shaft 16 such that the shaft 16 is rotated axially about the axis, A-A (FIG. 2), in the passage 36 of the shaft portion 28 to overcome the friction resistance provided by the interaction of the toothed or grooved portions 34, 38 of each of the shaft 16 and shaft portion 28. Corresponding to the description associated with FIGS. 3A-3C, the rotation of the shaft 16 about the axis, A-A, is generally defined by the angle, 0, as referenced from a first positioning of a toothed portion 34a of the shaft 16, as referenced in FIG. 3A.

According to an embodiment, the frictional resistance is overcome due to elastic material properties of the shaft portion 28. As illustrated in FIGS. 3A and 3B, the gap 30 extending across a length, L_{G}, of the second member 14 provides a means to resiliently move the shaft portion 28 from an at rest portion (FIG. 3A) away from the shaft 16 (i.e., the shaft portion 28 ‘opens’ along the length, L_{G}) in the direction of arrow, O (FIG. 3B), to a flexed position as the toothed or grooved portions 34 of the shaft 16 slips across the toothed or grooved portions 38 of the shaft portion 28. Then, as seen in FIGS. 3B and 3C, further movement of the first member 12 by way of the force, F, causes the toothed or grooved portions 34 of the shaft 16 to slip into the grooved portions 38 of the shaft portion 28, thereby closing the gap 30 and permitting the shaft portion 28 to move in a direction of arrow, O′, opposite that of the arrow, O, from the flexed position of FIG. 3B back to an at-rest position similar to that of FIG. 3A.

Referring to FIG. 4, a friction hinge 100 is shown according to an embodiment. The friction hinge 100 is substantially similar to the friction hinge 10 except that the friction hinge 100 includes an optional spring steel clip 102 that circumferentially wraps-around a shaft portion 128. Because the spring steel clip 102 wraps-around the shaft portion 128, additional circumferential clamping resistance is provided to the shaft portion 128 such that additional force, F, is to be provided to permit movement of the shaft portion 128 in the direction of the arrow, O, as described in FIG. 3B.

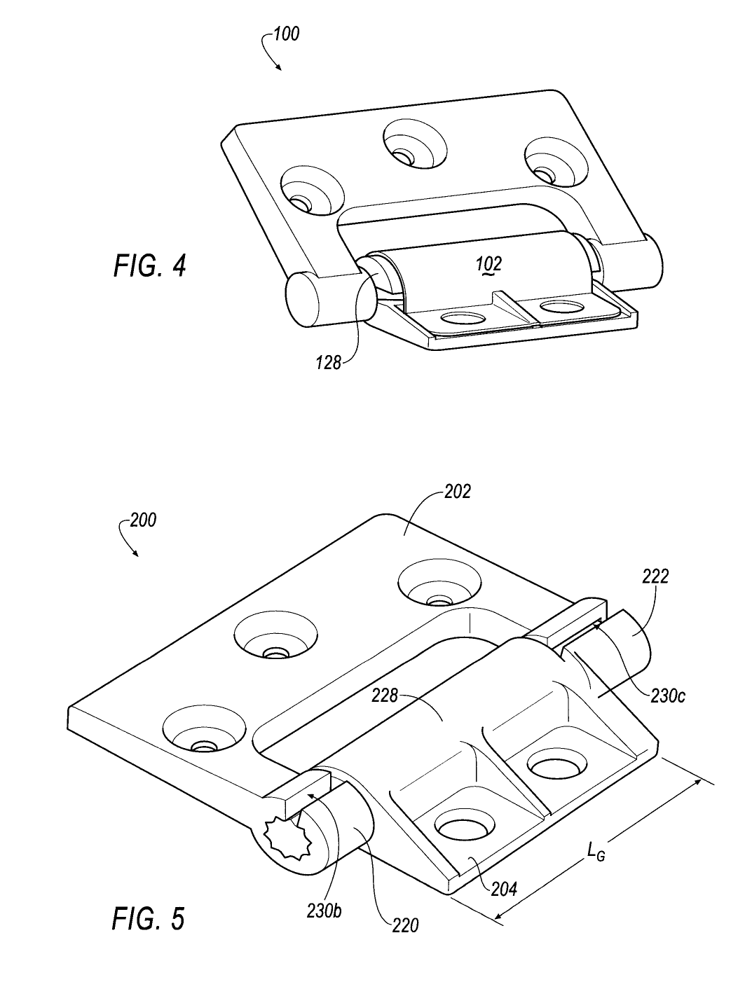

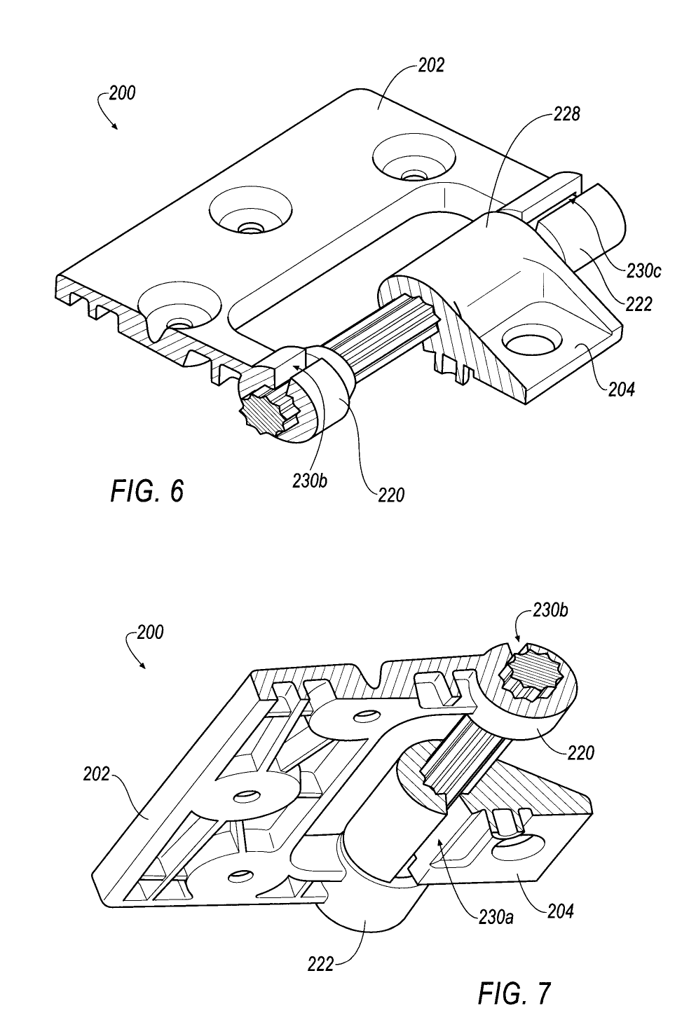

Referring to FIGS. 5-7 a friction hinge 200 is shown according to an embodiment. The friction hinge 200 is substantially similar to the friction hinge 10, 100 including a gap 230a (FIG. 7) extending across a length, L_{G}, of the second member 204. Additionally, one or more second gaps 230b, 230c are provided, respectively, at first and second ends 220, 222 of the C-shaped first member 202. According to an embodiment, spring steel clips (not shown) may be provided over the first and second ends 220, 222 of the first member 202, or, alternatively, over the shaft portion 228, in a substantially similar fashion as shown in FIG. 4 as related to the shaft portion 128.

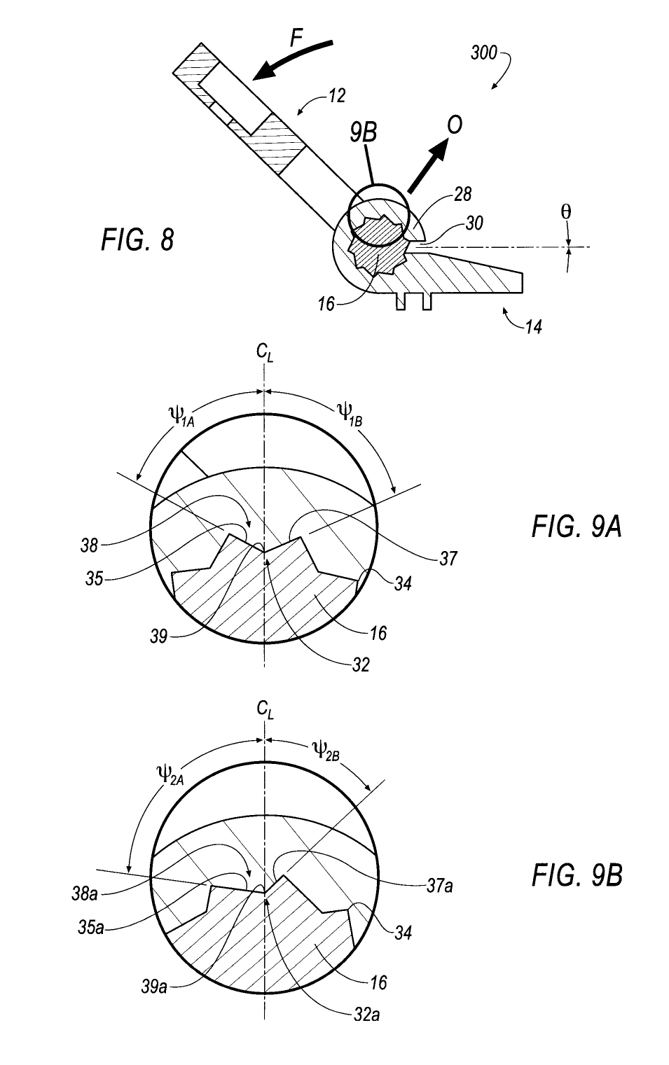

Referring to FIG. 8, a friction hinge is shown generally at 300 according to an embodiment. The friction hinge 300 is substantially similar to the friction hinge 10 of FIG. 3A except that the friction hinge includes a shaft 16 including a circumferential profile 32a and a passage of the shaft portion 28 including a grooved portion 38a that is substantially different from the circumferential profile 32 and grooved portion 38 of the friction hinge 10.

Referring to FIG. 9A, a magnified view of the shaft 16 of FIG. 3A is shown according to an embodiment. As illustrated, the circumferential profile 32 includes the splined surface having toothed or grooved portions 34 defined by a plurality of neighboring axial edge surfaces, which are shown generally at 35, 37. According to the embodiment, each pair of neighboring axial edge surfaces 35, 37 define a pair of spline angles, φ_{1A}, φ_{1B}, that are defined by a center-line, C_{L}, that radially extends from the axis of rotation, A-A, of the shaft 16 through a point or valley 39 where the axial edge surfaces 35, 37 meet. According to an embodiment, each axial edge surface 35, 37 includes a substantially similar length, and, are disposed in a manner to be spaced from the center-line, C_{L}, at a substantially similar angle, φ_{1A}, φ_{1B}. According to an embodiment, each spline angles, φ₁, φ_{1B}, may be approximately equal to, for example, 60°.

Referring to FIG. 9B, a magnified view of the shaft 16 of FIG. 8 is shown according to an embodiment. As illustrated, the circumferential profile 32a includes the splined surface having toothed or grooved portions 34 defined by a plurality of neighboring axial edge surfaces, which are shown generally at 35a, 37a. According to the embodiment, each pair of neighboring axial edge surfaces 35a, 37a define a pair of spline angles, φ_{2A}, φ_{2B}, that are defined by a center-line, C_{L}, that radially extends from the axis of rotation, A-A, of the shaft 16 through a point or valley 39a where the axial edge surfaces 35a, 37a meet. According to an embodiment, each axial edge surface 35a, 37a may include, for example, a substantially different length, and, are disposed in a manner to be spaced from the center-line, C_{L}, at a substantially different angle, φ_{2A}, φ_{2B}. According to an embodiment, the spline angle, φ_{2A}, may be approximately equal to, for example, 60°, whereas the spline angle, φ_{2B}, may be approximately equal to, for example, 40°.

Accordingly, it will be appreciated that the neighboring axial edge surfaces 35, 37 and 35a, 37a may define any desirable spline angle, φ_{1A}, φ_{1B}, φ_{2A}, φ_{2B}. As such, it will be appreciated upon considering the present disclosure that the orientation of the axial edge surfaces 35, 37, 35a, 37a and spline angles, φ_{1A}, φ_{1B}, φ_{2A}, φ_{2B}, may result in an increase or decrease in force, F, to cause movement of the first member 12 relative the second member 14. For example, because the spline angles, φ_{1A}, φ_{1B}, are substantially the same in FIG. 9A, the force, F, to move the first member in a clock-wise or counter-clockwise direction is relatively the same. Conversely, the angular disposition of the spline angles, φ_{2A}, φ_{2B}, as shown in FIG. 9B results in an increase in force, F, for counter-clockwise movement of the first member 12 and a decrease in force, F, for clockwise movement of the first member 12.

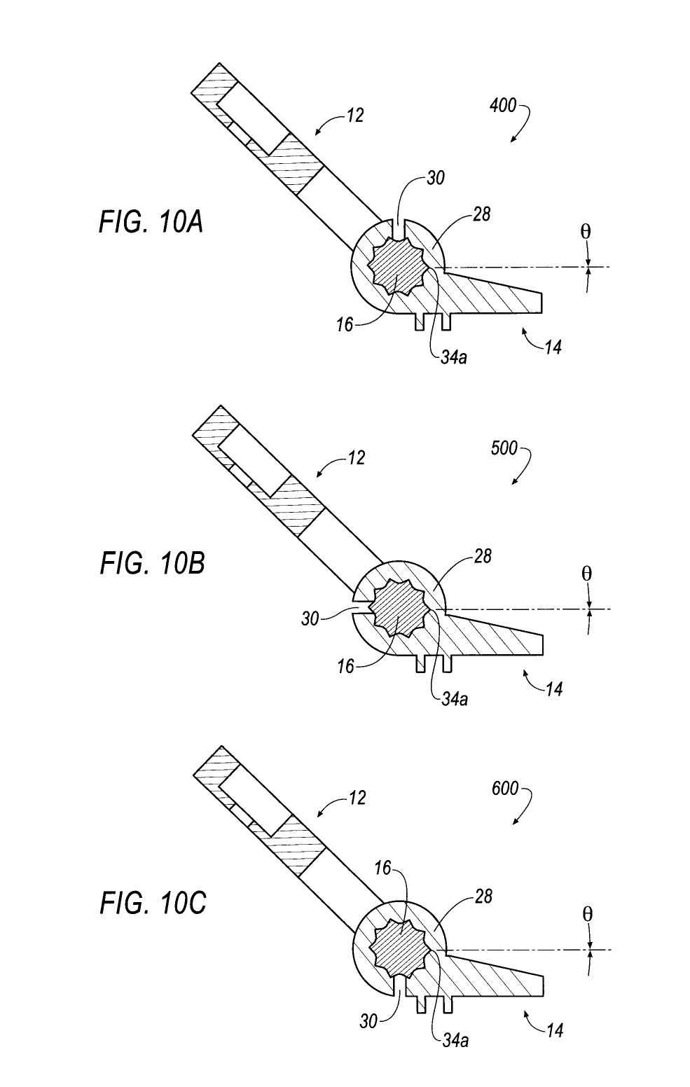

Referring to FIG. 10A, an alternative embodiment of the friction hinge 10 is shown generally at 400 according to an embodiment. The friction hinge 400 is substantially similar to the friction hinge 10 shown in FIG. 3A with the exception that the gap 30 is provided with the second member 14 at a position that is shifted 90° in the counter-clockwise direction relative the gap 30 of FIG. 3A (i.e., the shift in location of the gap 30 is substantially similar to that as the gap 230b, 230c shown in FIG. 5). As illustrated in FIG. 10B another embodiment of a friction hinge 500 illustrates the gap 30 of the second member 14 at a position that is shifted 180° relative the gap 30 of FIG. 3A. As illustrated in FIG. 10C, another embodiment of a friction hinge 600 illustrates the gap 30 is provided with the second member 14 at a position that is shifted 270° in the counter-clockwise direction relative the gap 30 of FIG. 3A (i.e., the shift in location of the gap 30 is substantially similar to that as the gap 230a shown in FIG. 7).

Accordingly, it will be appreciated that the gap 30 may be disposed in the second member 14 at any desirable location. According to an embodiment, the location of the gap 30 may result in an increase or decrease in the force, F, that causes movement of the first member 12 relative the second member 14. For example, as the location of the gap 30 deviates, in an increased counter-clockwise positioning shown in FIGS. 9A-9C as referenced from FIG. 3A, a greater amount of force, F, results to cause movement of the first member 12 relative the second member 14 in the direction as shown in FIGS. 3A-3C. Conversely, when a force, F, is applied to the first member 12 in the opposite direction to that as shown in FIGS. 3A-3C, the result is a reduced amount of force, F, applied to the first member 12 in the opposite direction as shown in FIGS. 3A-3C.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A sub-component of a friction hinge (10, 100, 200, 300, 400, 500, 600), comprising:
a member (14, 204) including a connection portion (28, 128, 228) defining a passage (36), wherein the passage (36) includes a splined circumferential inner periphery (38), and wherein the member (14, 204) defines a gap (30, 230a); and
a shaft (16) including a splined (34) circumferential outer profile (32) movably-engaged with the circumferential inner periphery (38) of the member (14, 204a) to connect the connection portion (28, 128, 228) about an axis of rotation (A-A) extending through the shaft (16), wherein the gap (30, 230a) axially extends in a substantial parallel relationship to the axis of rotation (A-A).

2. The sub-component of a friction hinge (10, 100, 200, 300, 400, 500, 600) according to claim 1, wherein the splined (34) circumferential profile (32) of the shaft (16) includes a plurality of neighboring axial edge surfaces (35, 37) demarcated by a valley (39), wherein a center-line (C_{L}) radially extends from the axis of rotation (A-A) of the shaft (16) through the valley (39), wherein the axial edge surfaces (35, 37) and center-line (C_{L}) define a pair of spline angles (φ_{1A}, φ_{1B}).

3. The sub-component of a friction hinge (10, 100, 200, 300, 400, 500, 600) according to claim 2, wherein the pair of spline angles (φ_{1A}, φ_{1B}) are equal.

4. The sub-component of a friction hinge (10, 100, 200, 300, 400, 500, 600) according to claim 2, wherein the pair of spline angles (φ_{1A}, φ_{1B}) are not equal.

5. The sub-component of a friction hinge (10, 100, 200, 300, 400, 500, 600) according to claim 1, wherein the member includes one or more fastener passages (18).

6. The sub-component of a friction hinge (100) according to claim 1 further comprising
a spring steel clip (102) circumferentially disposed about the connection portion (128).

7. The sub-component of a friction hinge (10, 100, 200, 300, 400, 500, 600) according to claim 1, wherein the gap (30, 230a) extends across a majority length (L_{G}) of the connection portion (28, 128, 228).

8. The sub-component of a friction hinge (10, 100, 200, 300, 400, 500, 600) according to claim 1, wherein the connection portion (28, 128, 228) defines a shaft portion that partially circumscribes the shaft (16) to define the gap (30, 230a).

9. The sub-component of a friction hinge (10, 100, 200, 300, 400, 500, 600) according to claim 1, wherein the shaft (16) includes a rigid material, wherein the member (14, 204a) includes an elastic material.

10. A friction hinge (10, 100, 200, 300, 400, 500, 600), comprising:
a shaft (16) including a first end (24), a second end (26) and a splined (34) circumferential profile (32);
a first member (12, 202) having first and second ends (20, 22, 220, 222), wherein at least one of the first and second ends (20, 22, 220, 222) that are rigidly fixed to at least one of the first and second ends (24, 26) of the shaft (16);
a second member (14, 204) pivotably-connected to the shaft (16) about an axis of rotation (A-A) extending through the shaft (16), wherein the second member (14, 204) includes a connection portion (28, 128, 228) defining a passage (36), wherein the passage (36) includes a splined circumferential inner periphery (38), wherein the second member (14, 204) further defines a gap (30, 230a) that axially extends in a substantial parallel relationship to the axis of rotation (A-A).

11. The friction hinge (100) according to claim 10 further comprising
a spring steel clip (102) circumferentially disposed about the connection portion (128).

12. The friction hinge (10, 100, 200, 300, 400, 500, 600) according to claim 10, wherein the gap (30, 230a) extends across a majority length (L_{G}) of the connection portion (28, 128, 228).

13. The friction hinge (10, 100, 200, 300, 400, 500, 600) according to claim 10, wherein the connection portion (28, 128, 228) defines a shaft portion that partially circumscribes the shaft (16) to define the gap (30, 230a).

14. The friction hinge (10, 100, 200, 300, 400, 500, 600) according to claim 10, wherein the shaft (16) includes a rigid material, wherein the second member (14, 204a) includes an elastic material.

15. The friction hinge (10, 100, 200, 300, 400, 500, 600) according to claim 10, wherein the splined (34) circumferential profile (32) of the shaft (16) includes a plurality of neighboring axial edge surfaces (35, 37) demarcated by a valley (39), wherein a center-line (C_{L}) radially extends from the axis of rotation (A-A) of the shaft (16) through the valley (39), wherein the axial edge surfaces (35, 37) and center-line (C_{L}) define a pair of spline angles (φ_{1A}, φ_{1B}).

16. The friction hinge (10, 100, 200, 300, 400, 500, 600) according to claim 15, wherein the pair of spline angles φ_{1A}, φ_{1B}) are equal.

17. The friction hinge (10, 100, 200, 300, 400, 500, 600) according to claim 15, wherein the pair of spline angles (φ_{1A}, φ_{1B}) are not equal.

18. The friction hinge (10, 100, 200, 300, 400, 500, 600) according to claim 10, wherein one or more of the first and second members (12, 202, 14, 204) includes one or more fastener passages (18).

19. A friction hinge (200), comprising:
a shaft (16) including a first end (24), a second end (26) and a splined (34) circumferential profile (32);
a first member (202) having first and second ends (220, 222) one or both of which are rigidly fixed to one or both of the first and second ends (24, 26) of the shaft (16), wherein the first end (220) of the first member (200) defines a first gap (230b), wherein the second end (22s) of the first member (200) defines a second gap (230c);
a second member (204) pivotably-connected to the shaft (16) about an axis of rotation (A-A) extending through the shaft (16), wherein the second member (204) includes a connection portion (228) defining a passage (36), wherein the passage (36) includes a splined circumferential inner periphery (38), wherein the second member (204) defines a third gap (230a), wherein the first, second, and third gaps (230a, 230b, 230c) axially extend in a substantial parallel relationship to the axis of rotation (A-A).

20. The friction hinge (200) according to claim 19, wherein the first gap (230b) extends across a majority length of the first end (220) of the first member (202), wherein the second gap (230c) extends across a majority length of the second end (222) of the first member (202), wherein the third gap (230a) extends across a majority length (L_{G}) of the connection portion (228).

21. The friction hinge (200) according to claim 19, wherein the connection portion (228) defines a shaft portion that partially circumscribes the shaft (16) to define the gap (230a).

22. The friction hinge (200) according to claim 19, wherein the shaft (16) includes a rigid material, wherein the second member (204a) includes an elastic material.

23. The friction hinge (200) according to claim 19, wherein the splined (34) circumferential profile (32) of the shaft (16) includes a plurality of neighboring axial edge surfaces (35, 37) demarcated by a valley (39), wherein a center-line (CO radially extends from the axis of rotation (A-A) of the shaft (16) through the valley (39), wherein the axial edge surfaces (35, 37) and center-line (CO define a pair of spline angles (φ_{1A}, φ_{1B}).

24. The friction hinge (200) according to claim 23, wherein the pair of spline angles (φ_{1A}, φ_{1B}) are equal.

25. The friction hinge (200) according to claim 23, wherein the pair of spline angles (φ_{1A}, φ_{1B}) are not equal.

26. The friction hinge (200) according to claim 19, wherein one or more of the first and second members (202, 204) includes one or more fastener passages (18).
